(19) United States
(12) Patent Application Publication
(10) Pub. No.: US 2018/0057954 A1
(43) Pub. Date: Mar. 1, 2018

(54) METHOD FOR PRODUCING HEAT-SHIELDING FILM

(71) Applicant: TOYOTA JIDOSHA KABUSHIKI KAISHA, Toyota-shi (JP)

(72) Inventor: Hideo YAMASHITA, Mishima-shi (JP)

(73) Assignee: TOYOTA JIDOSHA KABUSHIKI KAISHA, Toyota-shi (JP)

(21) Appl. No.: 15/652,525

(22) Filed: Jul. 18, 2017

(30) Foreign Application Priority Data
Aug. 29, 2016 (JP) 2016-167045

(51) Int. Cl. C25D 11/24; C25D 11/30; C25D 11/26; C25D 11/02; F02B 77/11

(52) U.S. Cl. CPC C25D 11/246; C25D 11/30; F02B 77/11; C25D 11/022; C25D 11/26

(57) ABSTRACT

A pore sealing treatment is performed in order to enhance the heat-shielding property of an anode oxide film by blocking at least the openings of open pores. In the first step of the pore sealing treatment, a non-solvent-typed pore sealing agent (first pore sealing agent) is used, and a first silicon-based oxide film is formed. In the second step of the pore sealing treatment, a solvent-typed pore sealing agent (second pore sealing agent) is used, and a second silicon-based oxide film is formed. The inorganic polymer constituting the second silicon-based oxide film 18 has a higher melting point and a sufficiently higher hardness as compared with the inorganic polymer constituting the first silicon-based oxide film 16. Therefore, it is possible to obtain a heat-shielding film having a high real machine durability.

### CROSS-REFERENCE TO RELATED APPLICATION

The present application claims priority under 35 U.S.C. §119 to Japanese Patent Applications No. 2016-167045, filed on Aug. 29, 2016. The contents of these applications are incorporated herein by reference in their entirety.

### TECHNICAL FIELD

The present disclosure relates to a method for producing a heat-shielding film, in particular, a method for producing a heat-shielding film provided on a constitutional surface of a combustion chamber of an engine.

### BACKGROUND

In general, when a cylinder head and a cylinder block are assembled together, a combustion chamber of an engine is defined as a space surrounded by the bore surface of the cylinder block, the top surface of a piston enclosed by the bore surface, the bottom surface of the cylinder head, and the bottom surfaces of the head parts of an intake valve and an exhaust valve provided in a prescribed location in the cylinder head. On the constitutional surface of such a combustion chamber, a heat-shielding film is sometimes provided, for the purpose of reducing the cooling loss in the engine, or protecting the engine from the heat generated by the combustion of fuel.

JP 2010-249008 A discloses a technique for providing an anode oxide film as a heat-shielding film, on the constitutional surface of the combustion chamber of an engine. The anode oxide film has a thermal conductivity lower than the thermal conductivities of the base materials (for example, an aluminum alloy, a magnesium alloy, a titanium alloy) of the parts constituting the combustion chamber. Consequently, the anode oxide film allows the heat-shielding property of the combustion chamber to be improved and the cooling loss to be reduced. In addition, the anode oxide film has a volume heat capacity lower than the volume heat capacities of the above-described base materials. Accordingly, the anode oxide film also allows the surface temperature of the film to be made to follow the temperature of the working gas in the combustion chamber. Specifically, the surface temperature of the film can be made to follow the intake temperature in the intake stroke, and the temperature of the combustion gas in the expansion stroke. Accordingly, the anode oxide film allows the cooling loss in the expansion stroke to be reduced, and at the same time, allows the heating of the working gas in the intake stroke to be suppressed and the fuel consumption to be improved.

JP 2010-249008 A also discloses that it is preferable to perform a treatment of sealing innumerable pores formed on the top surface of the anode oxide film (pore sealing treatment). As an example of the pore sealing treatment, Patent Literature 1 introduces a method in which an organic silicon solution is applied as a pore sealing agent to the top surface of the anode oxide film, and heated so as to form a silicon-based oxide film.

JP 2002-363539 A discloses a pore sealing agent which seals pores formed on a top surface of a thermal spraying product. The pore sealing agent is a non-solvent-typed pore sealing agent including an alkoxysilane compound represented by the following chemical formula (1) or a partially hydrolyzed condensate thereof:

R¹ₙSi(OR²)₄₋ₙ (1)

(In formula (1), R¹ represents a substituted or unsubstituted monovalent hydrocarbon group having 1 to 8 carbon atoms, R² represents an alkyl group having 1 to 4 carbon atoms and n represents an integer of 0 to 3.)

JP 2009-280716 A discloses a non-solvent-typed pore sealing agent which includes almost the same alkoxysilane compound discloses in JP 2002-363539 A as a pore sealing agent to seal pores formed on a top layer of a porous material.

Neither JP 2002-363539A nor JP 2009-280716 A mention about a constitutional surface of a combustion chamber of an engine. Here, if the non-solvent-type sealing agent disclosed in these patent documents are applied in substitution for the organic silicon solution of JP 2010-249008 A, the innumerable pores on the top surface of the anode oxide film are sealed. However, it is clear from the formula (1) that the alkoxysilane compound includes hydrocarbon group within a molecule. Therefore, it is estimated that a pore sealing film obtained from the alkoxysilane compound has lower melting temperature as compared with the silicon-based oxide film obtained from the organic silicon solution. That is, the pore sealing treatment with the non-solvent-type sealing agent disclosed in JP 2002-363539A or JP 2009-280716 A has concerns about heat resistance of the pore sealing film obtained from the sealing agent.

The present disclosure addresses the above-described problems, and an object of the present disclosure is to provide a production method capable of enhancing the heat resistance of the pore sealing film formed on the top surface of the anode oxide film.

### SUMMARY

The present disclosure is a method for producing a heat-shielding film for achieving the above-described object, and comprises an anode oxidation step, a first pore sealing step and a second pore sealing step. The anode oxidation step is a step of forming an anode oxide film having a top surface provided with innumerable pores formed thereon, by the anode oxidation treatment of the part constituting the combustion chamber of an engine. The first pore sealing step is a step of forming a first silicon-based oxide film by applying, to the top surface of the anode oxide film, a non-solvent-type first pore sealing agent including an alkoxysilane compound represented by the following chemical formula (1) or a partially hydrolyzed condensate thereof, and by the polymerization of at least one of the alkoxysilane compound and the partially hydrolyzed condensate thereof:

R¹ₙSi(OR²)₄₋ₙ (1)

(In formula (1), R¹ represents a substituted or unsubstituted monovalent hydrocarbon group having 1 to 8 carbon atoms, R² represents an alkyl group having 1 to 4 carbon atoms and n represents an integer of 0 to 3.)

The second pore sealing step is a step of forming a first silicon-based oxide film by applying, to the top surface of the first silicon-based oxide film, a solvent-typed second pore sealing agent including polysilazane and an organic solvent, and by the polymerization of the polysilazane involving the removal of the organic solvent of the second pore sealing agent.

In the present disclosure, the polysilazane included in the second pore sealing agent may be perhydropolysilazane.

According to the present disclosure, the top surface of the heat-shielding film can be constituted with the second silicon-based oxide film. The polymer constituting the second silicon-based oxide film is a polymer derived from polysilazane, and is excellent in heat resistance as compared with the polymer constituting the first silicon-based oxide film. Accordingly, as compared with the case where the top surface of the heat-shielding film is constituted with the first silicon-based oxide film, the heat resistance of the top surface concerned can be improved.

In the present disclosure, when the polysilazane included in the second pore sealing agent is perhydropolysilazane, the top surface of the heat-shielding film can be constituted with a silica glass, and accordingly the heat resistance of the top surface concerned can be particularly improved.

### BRIEF DESCRIPTION OF DRAWINGS

FIG. 1 is a diagram illustrating the flow of the method for producing a heat-shielding film according to an embodiment of the present disclosure;

FIG. 2 is a cross-sectional schematic diagram of an anode oxide film formed on the base material of a combustion chamber part;

FIG. 3 is a cross-sectional schematic diagram of an anode oxide film on which a first silicon-based oxide film is formed;

FIG. 4 is a diagram schematically illustrating the reaction of alkoxysilane compounds;

FIG. 5 is a cross-sectional schematic diagram of an anode oxide film on which a second silicon-based oxide film is formed;

FIG. 6 is a diagram schematically illustrating the reaction of perhydropolysilazane;

FIG. 7 is a diagram schematically illustrating the top surface of an anode oxide film before a pore sealing treatment;

FIG. 8 is a diagram illustrating the problematic points in the case where the openings of open pores or crack openings are incompletely blocked; and

FIG. 9 is a diagram illustrating the effects when the first silicon-based oxide film 16 is formed on the top surface 10a.

### DESCRIPTION OF EMBODIMENTS

Hereinafter, the embodiment of the present disclosure are described with reference to the accompanying drawings. It is to be noted that the common elements in the drawings are denoted by the same reference signs and the duplicate descriptions thereof are omitted. The present disclosure is not limited by the following embodiment.

### Description of Production Method

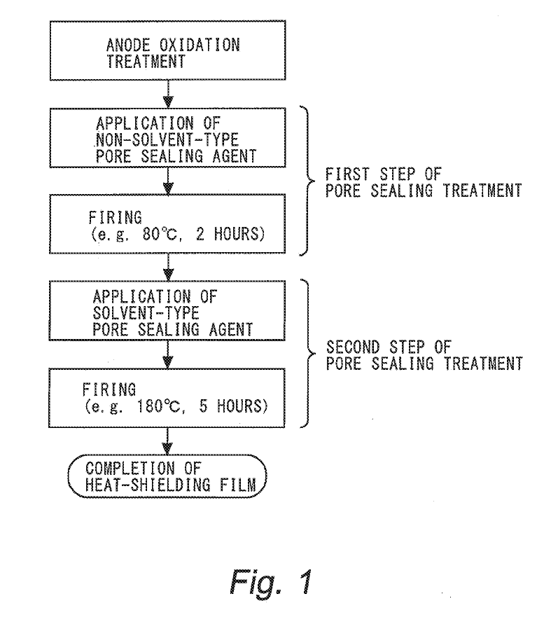

FIG. 1 is a diagram illustrating the flow of the method for producing a heat-shielding film according to an embodiment of the present disclosure. In the production method according to the present embodiment, first, an anode oxidation treatment of the part (hereinafter, referred to as a “combustion chamber part”) constituting a combustion chamber of an engine is performed. As already described, the combustion chamber of an engine is defined as a space surrounded by the bore surface of the cylinder block, the top surface of a piston enclosed by the bore surface, the bottom surface of the cylinder head, and the bottom surfaces of the head parts of an intake valve and an exhaust valve provided in a prescribed location in the cylinder head. The combustion chamber part of the present embodiment includes at least one of the cylinder block, the cylinder head, the piston, the intake valve and the exhaust valve.

The anode oxidation treatment is an electrolysis performed while an electrolyte solution (as an example, an aqueous solution of phosphoric acid, oxalic acid, sulfuric acid, or chromic acid) is being supplied to the surface of the combustion chamber part as an anode. During the electrolysis, the electric current density and the energization time are regulated. During the electrolysis, the contact area of the electrolyte solution is restricted by using, for example, a masking agent in such a way that only a predetermined area of the surface of the combustion chamber part undergoes the formation of the anode oxide film. The base material of the combustion chamber part is, for example, an aluminum alloy, a magnesium alloy or a titanium alloy. Accordingly, when the anode oxidation treatment is performed, the oxide film of the alloy (namely, anode oxide film) is formed in the above-described predetermined area.

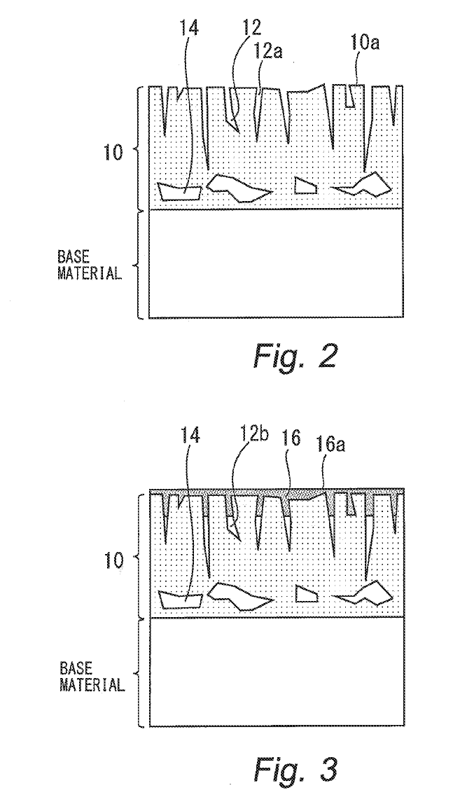

FIG. 2 is a cross-sectional schematic diagram of an anode oxide film formed on the base material of a combustion chamber part. The anode oxide film 10 shown in FIG. 2 has innumerable open pores 12 having openings on the top surface 10a. The open pores 12 are formed in the course of the anode oxidation treatment. The presence of the open pores 12 allows the anode oxide film 10 to function as a heat-shielding film having a lower thermal conductivity and a lower volume heat capacity (meaning a heat capacity per unit volume; the same shall apply hereinafter) than those of the base material of the combustion chamber part. The anode oxide film 10 has also closed pores 14 in the interior thereof. The closed pores 14 are formed in the course of the anode oxidation treatment, and are originated from the additives (mainly, Si) for improving the mechanical properties of the combustion chamber part. The presence of the closed pores 14 allows the low volume heat capacity of the anode oxide film 10 to be actualized.

In the production method according to the present embodiment, successively, the treatment (pore sealing treatment) for sealing the open pores 12 shown in FIG. 2 is performed. The pore sealing treatment is performed in order to enhance the heat-shielding property of the anode oxide film 10 by blocking at least the openings 12a of the open pores 12 close to the top surface 10a. The pore sealing treatment comprises a first step and a second step. In the first step of the pore sealing treatment, first, a non-solvent-typed pore sealing agent (first pore sealing agent) is applied to all the area of the top surface 10a shown in FIG. 2. The non-solvent-typed pore sealing agent includes an alkoxysilane compound represented by the following chemical formula (1) or a partially hydrolyzed condensate (oligomer) thereof:

R¹ₙSi(OR²)₄₋ₙ (1)

(In formula (1), R¹ represents a substituted or unsubstituted monovalent hydrocarbon group having 1 to 8 carbon atoms, R² represents an alkyl group having 1 to 4 carbon atoms and n represents an integer of 0 to 3.)

The non-solvent-typed pore sealing agent may include, if necessary, a curing catalyst regulating the rate of the curing reaction, an inorganic pigment coloring the resulting pore sealing film and an inorganic additive(s). The curing catalyst, the inorganic pigment and the inorganic additive(s) are not particularly limited, and heretofore known products can be used. Examples of the curing catalyst include: organotin compounds such as dibutyltin dilaurate and dibutyltin diacetate; organotitanium compounds such as tetraisopropoxy titanium and tetra-n-butoxy titanium; organoaluminum compounds such as triisopropoxy aluminum and tri-n-butoxy aluminum; and organozirconium compounds such as tetra-n-butoxy zirconium and tetra-n-propoxy zirconium. Examples of the inorganic pigment include a metal, an alloy, and the oxide, hydroxide, carbide, sulfide and nitride of these metal and alloy. Examples of the additive include a gloss modifier and a viscosity modifier.

As an example of the non-solvent-typed pore sealing agent, Permeate (trade name) manufactured by D&D Corp. is quoted. Permeate is a non-solvent one-component pore sealing agent mainly composed of an alkoxysilane compound represented by the above-described chemical formula (1) or a partially hydrolyzed condensate thereof.

The application method of the non-solvent-typed pore sealing agent is not particularly limited, and a heretofore known method can be used as the application method concerned. Examples of the heretofore known method include brush coating, spray coating, dip coating, float coating and spin coating. It is to be noted that the deposition of the pore sealing agent on the film surface during coating may unfortunately lead to the degradation of the surface roughness due to cracking or the increase of the volume heat capacity. Accordingly, when the solvent-typed pore sealing agent is deposited on the surface of the anode oxide film, the deposited pore sealing agent may be wiped off, for example, by using waste cloth after the application of the pore sealing agent.

In the first step of the pore sealing treatment, successively, the firing of the non-solvent-typed pore sealing agent is performed. For example, the firing conditions are such that the temperature is set at 80° C. and the firing time is set at 2 hours. By performing the firing of the non-solvent-typed pore sealing agent, the above-described alkoxysilane compound is polycondensed with itself, the above-described partially hydrolyzed condensate is polycondensed with itself or the alkoxysilane compound and the partially hydrolyzed condensate are polycondensed with each other. Consequently, a silicon-based oxide film (first silicon-based oxide film) is formed on the top surface 10a shown in FIG. 2. FIG. 3 is a cross-sectional schematic diagram of an anode oxide film on which a first silicon-based oxide film is formed. As shown in FIG. 3, the first silicon-based oxide film 16 is formed on the top surface 10a and the constitutional surface of the open pores 12. Consequently, most of the openings 12a are blocked by the first silicon-based oxide film 16. It is to be noted that FIG. 3 depicts the deep portion 12b of an open pore 12 not blocked by the first silicon-based oxide film 16. However, the formation of such a deep portion 12b itself causes no problem, and rather, when such a deep portion 12b functions similarly to the closed pores 14, such a deep portion 12b contributes to a low volume heat capacity of the heat-shielding film.

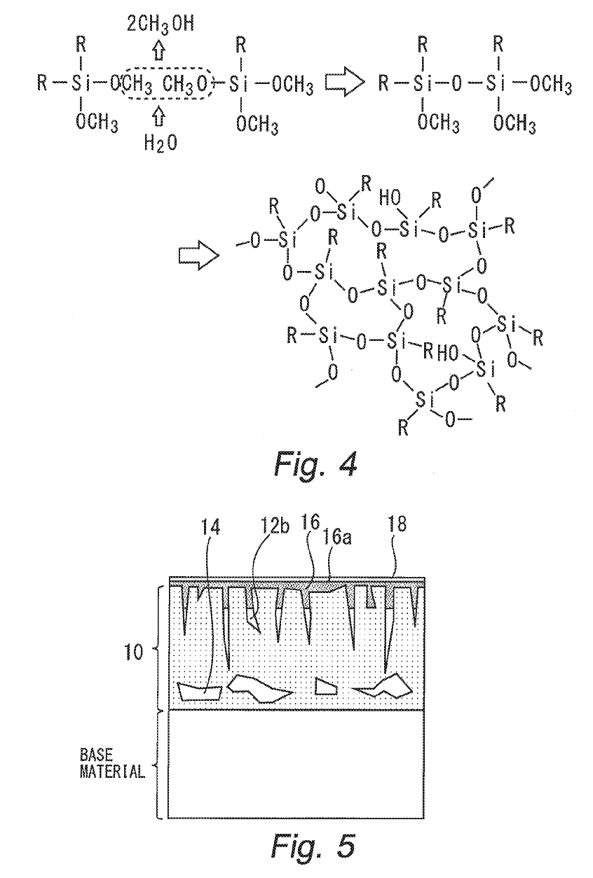

FIG. 4 is a diagram schematically illustrating the reaction of alkoxysilane compounds. As shown in FIG. 4, the alkoxysilane compound forms a network by reacting with water while releasing methanol (CH₃OH). When above-described Permeate is used as the non-solvent-typed pore sealing agent, the alkoxysilane compound or the partially hydrolyzed condensate thereof reacts with the moisture in the atmosphere, and consequently, formed is the first silicon-based oxide film 16 composed of an inorganic polymer having —Si—O—Si—O— as the main chain.

In the second step of the pore sealing treatment, first, a solvent-typed pore sealing agent (second pore sealing agent) is applied to all the area of the top surface 16a of the first silicon-based oxide film 16 shown in FIG. 3. The solvent-typed pore sealing agent includes perhydropolysilazane and/or organopolysilazane (as an example, polydimethyl silazane or poly (dimethyl-methyl) silazane) and an organic solvent. The solvent-typed pore sealing agent may include, if necessary, an additive(s). Examples of the additive include a leveling agent, a surfactant and a viscosity modifier.

As an example of the solvent-typed pore sealing agent, Aquamica (registered trademark) manufactured by AZ Electronic Materials Co., Ltd. is quoted. Aquamica is a product prepared by diluting perhydropolysilazane with an ethereal solvent such as dibutyl ether or anisole.

Similarly to the above-described non-solvent-typed pore sealing agent, the application method of the solvent-typed pore sealing agent is not particularly limited, and a heretofore known method can be used as the application method concerned. In addition, when the solvent-typed pore sealing agent is deposited on the surface of the first silicon-based oxide film, the deposited pore sealing agent may be wiped off, for example, by using waste cloth after the application of the solvent-typed pore sealing agent.

In the second step of the pore sealing treatment, successively, the firing of the solvent-typed pore sealing agent is performed. For example, the firing conditions are such that the temperature is set at 180° C. and the firing time is set at 5 hours. By performing the firing of the solvent-typed pore sealing agent, the above-described organic solvent evaporates, and at the same time, the polysilazane is polycondensed. Consequently, there is formed a silicon-based oxide film (second silicon-based oxide film) other than the first silicon-based oxide film 16 covering the top surface 16a shown in FIG. 3. FIG. 5 is a cross-sectional schematic diagram of an anode oxide film on which a second silicon-based oxide film is formed. As shown in FIG. 5, the second silicon-based oxide film 18 is formed on the top surface 16a.

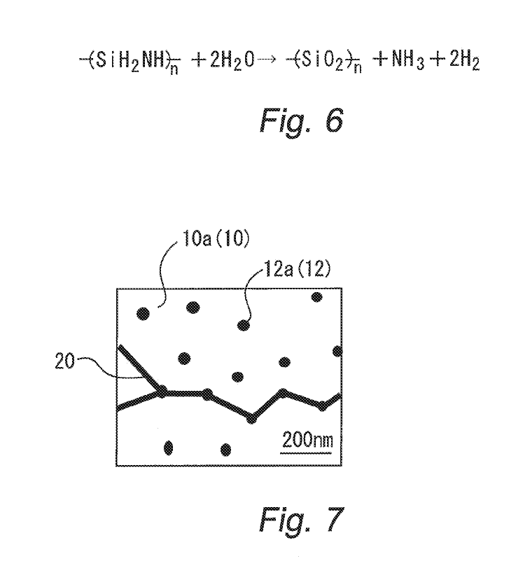

FIG. 6 is a diagram schematically illustrating the reaction of perhydropolysilazane. As shown in FIG. 6, perhydropolysilazane is converted into silica glass while reacting with water (H₂O) and releasing ammonia (NH₃) and hydrogen (H₂). When above-described Aquamica is used as the solvent-typed pore sealing agent, perhydropolysilazane reacts with the moisture in the atmosphere, and consequently the second silicon-based oxide film 18 composed of silica glass is formed.

Due to the above-described anode oxidation treatment and the above-described pore sealing treatment, a heat-shielding film is formed on the base material of the combustion chamber part. By the way, the anode oxide film 10, the first silicon-based oxide film 16 and the second silicon-based oxide film 18 shown in FIG. 5 correspond to the heat-shielding film obtained by the production method according to the present embodiment.

### Effects of Production Method

First, the effects according to the first step of the above-described pore sealing treatment is described with reference to FIG. 7. FIG. 7 is a diagram schematically illustrating the top surface of the anode oxide film before the pore sealing treatment. As shown in FIG. 7, innumerable openings 12a are dotted about on the top surface 10a. When these openings 12a are compared with each other, it is found that there are differences in the sizes thereof. As shown in FIG. 7, a crack opening 20 is formed on the top surface 10a. The crack opening 20 can be created in the course of the formation of the open pores 12. Similarly to the sizes of the openings 12a, the size of the crack opening 20 is also varied, and the size of the crack opening 20 shown in FIG. 7 is larger than the maximum size of the openings 12a shown in the same figure.

When the sizes of the openings 12a are large, or when the crack opening 20 is formed, if the second pore sealing agent is applied to the top surface 10a in advance of the application of the first pore sealing agent, it is impossible to completely block the openings 12a or the crack opening 20. This is because even when a solvent-typed pore sealing agent can be filled in all the openings 12a or all the crack openings 20 in the application step, the volume of the pore sealing agent is reduced by the amount of the organic solvent evaporated in the subsequent firing step. When the volume of the pore sealing agent is decreased, the openings 12a and the crack openings 20 incompletely blocked by the second silicon-based oxide film 16 remain.

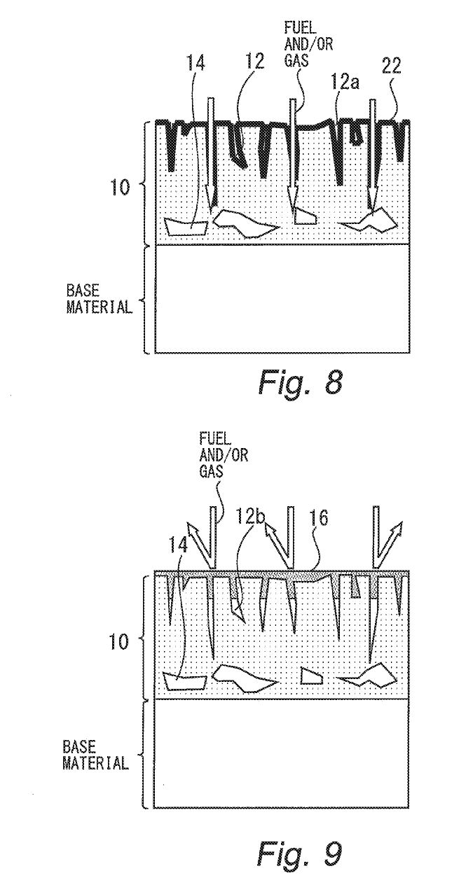

FIG. 8 is a diagram illustrating the problematic points in the case where the openings of the open pores or the crack openings are incompletely blocked. If the second pore sealing agent is applied to the top surface 10a in advance of the application of the first pore sealing agent, there is formed on the top surface 10a a silicon-based oxide film (a third silicon-based oxide film) which has the same composition as the second silicon-based film. However, for the reasons mentioned above, it is impossible to completely block all the openings 12a by the third silicon-based oxide film 22. Then, the combustion gas can invade into the incompletely blocked openings 12a. Accordingly, as compared with the case where the openings 12a are completely blocked, the heat-shielding property due to the anode oxide film 10 or the followability to the working gas is degraded. Also, in the case of a gasoline engine, it is possible that the fuel invading into the incompletely blocked openings 12a does not contribute to the combustion and remains in the incompletely blocked openings 12a.

With respect to this point, in the production method according to the present embodiment, the first step of the pore sealing treatment using a non-solvent-typed pore sealing agent is performed. In contrast to the solvent-typed pore sealing agent, the non-solvent-typed pore sealing agent is substantially free from the volume contraction in the application step or in the firing step. Consequently, all the openings 12a can be certainly blocked by the first silicon-based oxide film 16. FIG. 9 is a diagram illustrating the effects when the first silicon-based oxide film 16 is formed on the top surface 10a. As the arrows indicate in FIG. 9, when all the openings 12a are blocked by the first silicon-based oxide film 16, the invasion of the combustion gas or the fuel can be blocked. It is noted that the second silicon-based oxide film 18 shown in FIG. 5 is omitted in FIG. 9. However, since all the openings 12a are blocked by the first silicon-based oxide film 16, the invasion of the combustion gas or the fuel is assumed to be blocked when the second silicon-based oxide film 18 is formed on the first silicon-based oxide film 16.

Next, the effects according to the second step of the above-described pore scaling treatment is described. As can be seen from FIG. 4, the inorganic polymer constituting the first silicon-based oxide film 16 includes hydrocarbon groups in the side chains thereof. Accordingly, the inorganic polymer tends to have a lower melting temperature as compared with an inorganic polymer having no hydrocarbon groups at all in the side chains thereof. In fact, above-described Permeate has a melting temperature as low as approximately 500° C., and has a low hardness. Consequently, when the top surface of the heat-shielding film is constituted with the first silicon-based oxide film 16, an apprehension remains with respect to the heat resistance and the hardness.

From this aspect, in the production method according to the present embodiment, the second step is performed subsequent to first step. The inorganic polymer constituting the second silicon-based oxide film 18 has a higher melting point and a sufficiently higher hardness as compared with the inorganic polymer constituting the first silicon-based oxide film 16. In particular, the above-described silica glass formed from perhydropolysilazane has a melting point as high as approximately 1000° C. In this way, according to the production method according to the present embodiment, by the second step forming the second silicon-based oxide film 18, it is possible to obtain a heat-shielding film having a high real machine durability, and being enhanced in the heat resistance and the hardness of the top surface of the heat-shielding film.

What is claimed is:

1. A method for producing a heat-shielding film comprising the steps of:
forming an anode oxide film having a top surface provided with innumerable pores formed thereon, by the anode oxidation treatment of the part constituting the combustion chamber of an engine;
forming a first silicon-based oxide film by applying, to the top surface of the anode oxide film, a non-solvent-typed first pore sealing agent including an alkoxysilane compound represented by the following chemical formula (1) or a partially hydrolyzed condensate thereof, and by the polymerization of at least one of the alkoxysilane compound and the partially hydrolyzed condensate thereof; and
forming a second silicon-based oxide film by applying, to the top surface of the first silicon-based oxide film, a solvent-typed second pore sealing agent including polysilazane and an organic solvent, and by the polymerization of the polysilazane involving the removal of the organic solvent of the first pore sealing agent.
R¹ₙSi(OR²)₄₋ₙ (1)
(In formula (1), R¹ represents a substituted or unsubstituted monovalent hydrocarbon group having 1 to 8 carbon atoms, R² represents an alkyl group having 1 to 4 carbon atoms and n represents an integer of 0 to 3.)

2. The method for producing a heat-shielding film according to claim 1, wherein the polysilazane included in the second pore sealing agent is perhydropolysilazane.
